(19) United States
(12) Patent Application Publication
(10) Pub. No.: US 2017/0331529 A1
(43) Pub. Date: Nov. 16, 2017

(54) ELECTRONIC DEVICE AND WIRELESS COMMUNICATION METHOD IN ELECTRONIC DEVICE

(71) Applicant: Samsung Electronics Co., Ltd., Gyeonggi-do (KR)

(72) Inventors: Jung-Hun LEE, Gyeonggi-do (KR); Hyun-Kee Min, Gyeongsangbuk-do (KR); Young-Kow Lee, Gyeonggi-do (KR); Bu-Seop Jung, Gyeonggi-do (KR)

(73) Assignee: Samsung Electronics Co., Ltd.

(21) Appl. No.: 15/485,968

(22) Filed: Apr. 12, 2017

(30) Foreign Application Priority Data
May 13, 2016 (KR) 10-2016-0059113

(51) Int. Cl. H04B 7/0413; H04W 88/10

(52) U.S. Cl. CPC H04B 7/0413; H04W 88/10

(57) ABSTRACT

Provided are an electronic device and a wireless communication method of an electronic device. The electronic device obtains information for mode switching when the electronic device is connected to an access point based on one of a first mode from among a multiple user multiple input multiple output (MU-MIMO) mode and a single user multiple input multiple output (SU-MIMO) mode; determining whether to switch the mode to a second mode, which is different from the first mode, from among the MU-MIMO mode and the SU-MIMO mode, based on the obtained information for mode switching; and performing wireless data communication with the access point based on the second mode when the electronic device is switched to the second mode.

### PRIORITY

This application claims priority under 35 U.S.C. §119(a) to Korean Application Serial No. 10-2016-0059113, which was filed in the Korean Intellectual Property Office on May 13, 2016, the entire content of which is incorporated herein by reference.

### BACKGROUND

### 1. Field of the Disclosure

The present disclosure generally relates to an electronic device in a wireless communication system that uses a multiple input multiple output scheme, and a wireless communication method of an electronic device.

### 2. Description of the Related Art

To raise data transmission efficiency of data transmitted/received between an electronic device and an access point (AP) in a wireless communication network, a multiple input multiple output (MIMO) scheme may be used.

MIMO technology refers to an antenna system that is capable of performing multiple inputting and outputting, and may raise the capacity of a network using a plurality of antennas that an electronic device and an access point may have in a wireless network system. MIMO technology may be distinguished between a single user MIMO (SU-MIMO) and a multiple user MIMO (MU-MIMO), according to a data transmission/reception method.

Conventionally, an electronic device transmits/receives data to/from an access point using SU-MIMO. SU-MIMO indicates that each electronic device transmits/receives data only within an allocated time using a time division scheme for the data communication when a plurality of electronic devices are connected to a single AP.

Recently, as technologies have developed, MU-MIMO has been supported by an electronic device. Accordingly, an access point may transmit/receive data to/from each electronic device that supports MU-MIMO in parallel, using MU-MIMO. Through a multiple user diversity gain and a spatial multiplexing gain, MU-MIMO may obtain a higher frequency efficiency than SU-MIMO.

When an access point supports MU-MIMO, the access point may also support SU-MIMO, and may transmit/receive data based on the MU-MIMO until the connection is disconnected when receiving information indicating that MU-MIMO is supported during a connection process when the electronic device supports MU-MIMO.

Also, the access point may simultaneously transmit data to each of the electronic devices of a plurality of users, as opposed to using a time division scheme, and the capacity of a network may be increased. The increase in the total capacity of the network may lead to an improvement in the average performance of an electronic device.

However, the number of antennas that the access point has is limited, and a scheduling method that allocates an antenna using MU-MIMO is different for each AP existing in the wireless communication network, and thus, the capacity of the network that the electronic device may obtain may be different in reality.

Accordingly, although the capacity of the network increases as an electronic device performs wireless communication using MU-MIMO, the capacity of the network may not be equally allocated to electronic devices connected to the AP, and thus, it is possible that a particular electronic device may experience deterioration in performance of wireless communication even when executing wireless communication using MU-MIMO.

For example, when an electronic device having two antennas supports SU-MIMO, the electronic device may support a data transmission rate of 866 Mbps using both antennas. However, when an AP allocates only one antenna according to a MU-MIMO scheduling method, the electronic device may support a data transmission rate of 433 Mbps.

### SUMMARY

Accordingly, an aspect of the present disclosure provides an electronic device and a wireless communication method of an electronic device that effectively perform data transmission/reception based on a condition of wireless communication between an electronic device and an access point that support SU-MIMO and MU-MIMO in a wireless communication network.

According to an aspect of the present disclosure, there is provided an electronic device including a communication module that performs wireless data communication with an access point; and a processor configured to perform obtaining information for mode switching when an electronic device is connected to the access point based on one of a first mode from among a multiple user multiple input multiple output (MU-MIMO) mode and a single-user multiple input multiple output (SU-MIMO) mode; determining whether to switch the mode to a second mode, which is different from the first mode, from among the MU-MIMO mode and the SU-MIMO, based on the obtained information for mode switching; and performing wireless data communication with the access point based on the second mode when the electronic device is switched to the second mode.

According to another aspect embodiment of the present disclosure, there is provided a wireless communication method of an electronic device that performs wireless data communication with an access point, the method including obtaining information for mode switching when the electronic device is connected to the access point based on one of a first mode from among a multiple user multiple input multiple output (MU-MIMO) mode and a single user multiple input multiple output (SU-MIMO) mode; determining whether to switch the mode to a second mode, which is different from the first mode, from among the MU-MIMO and the SU-MIMO, based on the obtained information for mode switching; and performing wireless data communication with the access point based on the second mode when the electronic device is switched to the second mode.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 is a diagram illustrating a network environment according to an embodiment of the present disclosure;

FIGS. 2A and 2B are diagrams illustrating examples of a configuration of a wireless communication network according to an embodiment of the present disclosure;

FIGS. 3A and 3B are diagrams illustrating examples of a configuration of a wireless communication network according to an embodiment of the present disclosure;

FIG. 4 is a diagram illustrating an example of a configuration of an electronic device according to an embodiment of the present disclosure;

FIG. 5 is a diagram illustrating an example of a configuration of an access point according to an embodiment of the present disclosure;

FIG. 6 is a flowchart of an operation procedure of the electronic device according to an embodiment of the present disclosure;

FIG. 7 is a flow diagram of a wireless communication method between an electronic device and an access point according to an embodiment of the present disclosure;

FIG. 8 illustrates an example of a protocol including information indicating that multiple user multiple input multiple output is supported according to an embodiment of the present disclosure;

FIG. 9 is a flow diagram of a wireless communication method between an electronic device and an access point according to an embodiment of the present disclosure;

FIG. 10 illustrates an example of a message transmitted/received between an electronic device and an access point according to an embodiment of the present disclosure;

FIG. 11 is a diagram illustrating an example of a message transmitted/received between an electronic device and an access point according to various embodiments of the present disclosure;

FIG. 12 is a block diagram of an electronic device according to an embodiment of the present disclosure; and

FIG. 13 is a block diagram of a program module according to an embodiment of the present disclosure.

### DETAILED DESCRIPTION

Hereinafter, various embodiments of the present disclosure will be described with reference to the accompanying drawings. The embodiments and the terms used herein are not intended to limit the technology disclosed herein to specific forms, and should be understood to include various modifications, equivalents, and/or alternatives to the corresponding embodiments. In describing the drawings, similar reference numerals may be used to designate similar constituent elements.

A singular expression may include a plural expression unless they are definitely different in a context. As used herein, singular forms may include plural forms as well unless the context clearly indicates otherwise. The expressions “a first”, “a second”, “the first”, or “the second” used in various embodiments of the present disclosure may modify various components regardless of the order and/or the importance but do not limit the corresponding components. When an element (e.g., first element) is referred to as being “(functionally or communicatively) connected,” or “directly coupled” to another element (second element), the element may be connected directly to the another element or connected to the another element through yet another element (e.g., third element).

The expression “configured to” as used in various embodiments of the present disclosure may be interchangeably used with, for example, “suitable for”, “having the capacity to”, “designed to”, “adapted to”, “made to”, or “capable of” in terms of hardware or software, according to circumstances. Alternatively, in some situations, the expression “device configured to” may mean that the device, together with other devices or components, “is able to”. For example, the phrase “processor adapted (or configured) to perform A, B, and C” may mean a dedicated processor (e.g., embedded processor) only for performing the corresponding operations or a generic-purpose processor (e.g., central processing unit (CPU) or application processor (AP)) that can perform the corresponding operations by executing one or more software programs stored in a memory device.

An electronic device according to various embodiments of the present disclosure may include at least one of, for example, a smart phone, a tablet personal computer (PC), a mobile phone, a video phone, an electronic book reader (e-book reader), a desktop PC, a laptop PC, a netbook computer, a workstation, a server, a personal digital assistant (PDA), a portable multimedia player (PMP), a MPEG-1 audio layer-3 (MP3) player, a mobile medical device, a camera, and a wearable device. The wearable device may include at least one of an accessory type (e.g., a watch, a ring, a bracelet, an anklet, a necklace, a glasses, a contact lens, or a head-mounted device (HMD)), a fabric or clothing integrated type (e.g., an electronic clothing), a body-mounted type (e.g., a skin pad, or tattoo), and a bio-implantable type (e.g., an implantable circuit). In some embodiments, the electronic device may include at least one of, for example, a television, a digital video disk (DVD) player, an audio, a refrigerator, an air conditioner, a vacuum cleaner, an oven, a microwave oven, a washing machine, an air cleaner, a set-top box, a home automation control panel, a security control panel, a TV box (e.g., Samsung HomeSync™, Apple TV™, or Google TV™), a game console (e.g., XboX™ and PlayStation™), an electronic dictionary, an electronic key, a camcorder, and an electronic photo frame.

In other embodiments, the electronic device may include at least one of various medical devices (e.g., various portable medical measuring devices (a blood glucose monitoring device, a heart rate monitoring device, a blood pressure measuring device, a body temperature measuring device, etc.), a magnetic resonance angiography (MRA), a magnetic resonance imaging (MRI), a computed tomography (CT) machine, and an ultrasonic machine), a navigation device, a global positioning system (GPS) receiver, an event data recorder (EDR), a flight data recorder (FDR), a vehicle infotainment devices, an electronic devices for a ship (e.g., a navigation device for a ship, and a gyro-compass), avionics, security devices, an automotive head unit, a robot for home or industry, an automatic teller machine (ATM) in banks, a point of sales (POS) terminal in a shop, or an Internet of Things (IoT) device (e.g., a light bulb, various sensors, electric or gas meter, a sprinkler device, a fire alarm, a thermostat, a streetlamp, a toaster, a sporting goods, a hot water tank, a heater, a boiler, etc.).

According to some embodiments, an electronic device may include at least one of a part of furniture or a building/structure, an electronic board, an electronic signature receiving device, a projector, and various types of measuring instruments (e.g., a water meter, an electric meter, a gas meter, a radio wave meter, and the like). The electronic device may be flexible, or may be a combination of one or more of the aforementioned various devices. The electronic device is not limited to the above described devices. In the present disclosure, the term “user” may indicate a person using an electronic device or a device (e.g., an artificial intelligence electronic device) using an electronic device.

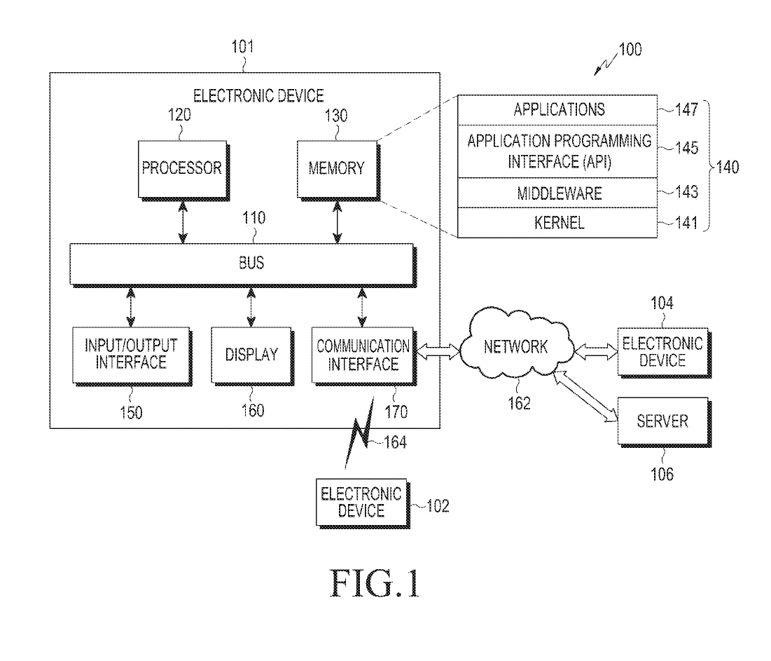

An electronic device 101 within a network environment 100, according to various embodiments of the present disclosure, will be described with reference to FIG. 1. The electronic device 101 may include a bus 110, a processor 120, a memory 130, an input/output interface 150, a display 160, and a communication interface 170. The electronic device 101 may omit at least one of the elements, or may further include other elements. The bus 110 may include, for example, a circuit for interconnecting the elements 110 to 170, and transferring communication (e.g., control messages and/or data) between the elements. The processor 120 may include one or more of a central processing unit, an AP, and a communication processor (CP). The processor 120, for example, may carry out operations or data processing relating to the control and/or communication of at least one other element of the electronic device 101.

The memory 130 may include a volatile and/or non-volatile memory. The memory 130 may store, for example, instructions or data relevant to at least one other element of the electronic device 101. According to an embodiment, the memory 130 may store software and/or a program 140. The program 140 may include, for example, a kernel 141, middleware 143, an application programming interface (API) 145, and/or application programs (or “applications”) 147. At least some of the kernel 141, the middleware 143, and the API 145 may be referred to as an operating system (OS). The kernel 141 may control or manage system resources (e.g., the bus 110, the processor 120, or the memory 130) used for executing an operation or function implemented by other programs (e.g., the middleware 143, the API 145, or the applications 147). Furthermore, the kernel 141 may provide an interface through which the middleware 143, the API 145, or the applications 147 may access the individual elements of the electronic device 101 to control or manage the system resources.

The middleware 143 may function as, for example, an intermediary for allowing the API 145 or the applications 147 to communicate with the kernel 141 to exchange data.

Furthermore, the middleware 143 may process one or more task requests, which are received from the applications 147, according to priorities thereof. For example, the middleware 143 may assign priorities for using the system resources (e.g., the bus 110, the processor 120, the memory 130, or the like) of the electronic device 101 to one or more of the applications 147. The API 145 is an interface used by the applications 147 to control a function provided from the kernel 141 or the middleware 143, and may include, for example, at least one interface or function (e.g., an instruction) for a file control, a window control, image processing, a character control, or the like. The input/output interface 150, for example, may transfer commands or data input from a user or another external device to other element(s) of the electronic device 101, or output commands or data received from other element(s) of the electronic device 101 to a user or another external device.

The display 160 may include, for example, a liquid crystal display (LCD), a light emitting diode (LED) display, an organic light emitting diode (OLED) display, a micro electro mechanical system (MEMS) display, or an electronic paper display. The display 160 may display, for example, various types of contents (e.g., text, images, videos, icons, symbols, or the like) to a user. The display 160 may include a touch screen and may receive, for example, a touch, gesture, proximity, or hovering input using an electronic pen or the user's body part. The communication interface 170 may establish communication, for example, between the electronic device 101 and an external device (e.g., a first external electronic device 102, a second external electronic device 104, or a server 106). For example, the communication interface 170 may be connected to a network 162 through wireless or wired communication to communicate with an external device 102, 104 or the server 106.

Wireless communication may include, for example, a cellular communication that uses at least one of LTE, LTE-Advance (LTE-A), code division multiple access (CDMA), wideband CDMA (WCDMA), universal mobile telecommunications system (UMTS), wireless broadband (WiBro), global system for mobile communications (GSM), etc. According to an embodiment, the wireless communication may include, for example, at least one of Wi-Fi, Bluetooth (BT), Bluetooth low energy (BLE), Zigbee, near field communication (NFC), magnetic secure transmission, radio frequency (RF), and body area network (BAN). The wired communication may include GNSS. The GNSS may be, for example, a global positioning system (GPS), a global navigation satellite system (Glonass), a Beidou navigation satellite system (Beidou), or Galileo (the European global satellite-based navigation system). Hereinafter, the “GPS” may be interchangeably used with the “GNSS” in the present disclosure.

Wired communication may include, for example, at least one of a universal serial bus (USB), a high definition multimedia interface (HDMI), recommended standard 232 (RS-232), a plain old telephone service (POTS), and the like. The network 162 may include a telecommunications network, for example, at least one of a computer network (e.g., a LAN or a WAN), the Internet, and a telephone network.

Each of the first and second external electronic devices 102 and 104 may be of a type same as, or different from, the electronic device 101. According to various embodiments, all or some of the operations executed in the electronic device 101 may be executed in another electronic device or a plurality of electronic devices, such as the electronic devices 102 and 104 or the server 106. When the electronic device 101 has to perform some functions or services automatically or by request, the electronic device 101 may request another device to perform at least some functions relating thereto instead of, or in addition to, performing the functions or services by itself. The other electronic device may perform the requested functions or the additional functions and may transfer an execution result to the electronic device 101. The electronic device 101 may provide the received result as it is, or may additionally process the received result to provide the requested functions or services. To this end, for example, cloud computing, distributed computing, or client-server computing technology may be used.

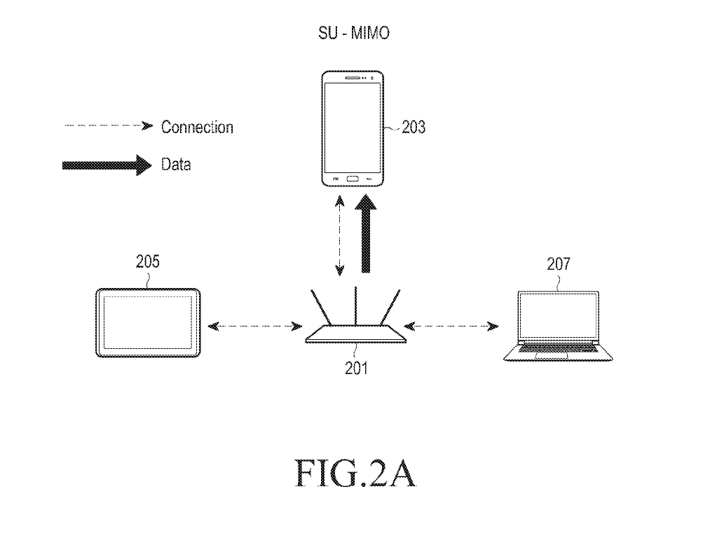

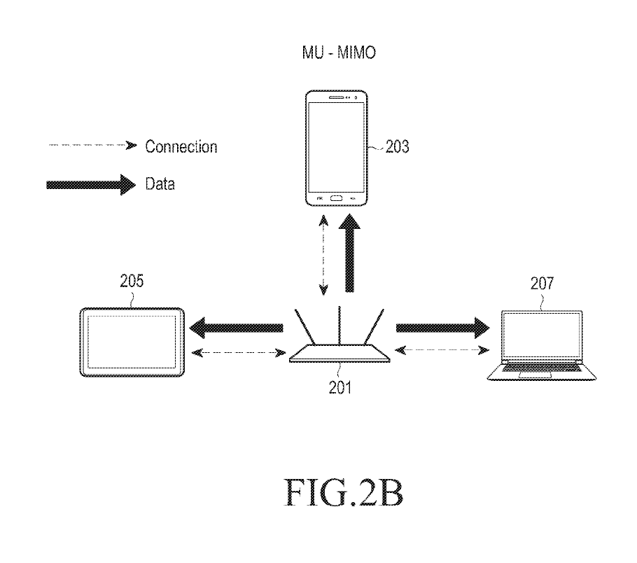

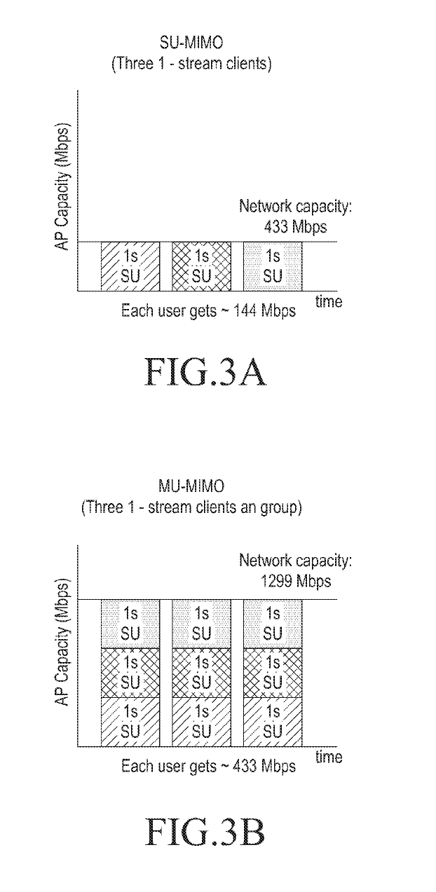

FIGS. 2A and 2B are diagrams illustrating examples of a configuration of a wireless communication network according to embodiments of the present disclosure. FIGS. 3A and 3B are diagrams illustrating examples of a configuration of a wireless communication network according to embodiments of the present disclosure. Here, in FIGS. 2A and 2B, an arrow expressed as a broken line indicates a connection between an access point and a plurality of electronic devices, and an arrow expressed as a solid line indicates wireless communication, that is, data transmission between an access point and a plurality of electronic devices.

According to various embodiments of the present disclosure, the multiple input multiple output (MIMO) technology may be used for wireless communication between an electronic device and an access point in a wireless communication network system. The electronic device and access point may support single-user MIMO (SU-MIMO) and multiple-user MIMO (MU-MIMO). Here, SU-MIMO is a scheme that allocates all antenna resources of an access point to a single user. MU-MIMO is a scheme that distributes an antenna resource or a radio spatial resource to a plurality of users according to an antenna allocation scheduling method.

Referring to FIG. 2A, an access point 201 may include a plurality of antennas, and may be connected to a plurality of electronic devices 203, 205, and 207. When the access point 201 executes wireless communication with electronic devices based on the SU-MIMO mode, the access point 201 may allocate all resources of the plurality of antennas to each of the plurality of electronic devices 203, 205, and 207, based on a time division scheme. Accordingly, the electronic device 203 may be assigned all resources of the plurality of antennas of the access point 201 according to a method scheduled by the access point 201, and the electronic device 203 may transmit/receive data through the allocated plurality of antennas of the access point 201, by applying the time division scheme.

Referring to FIG. 3A, for example, the access point 201 may transmit a spatial stream formed in the plurality of antennas to a single user (that is, the electronic device 203), according to the time division scheme, and may provide the maximum data transmission rate (e.g., 433 Mbps) that indicates the maximum physical link speed of the access point 201. When the access point 201 has three spatial streams, the maximum data transmission rate that each electronic device 203, 205, and 207 may obtain through a single antenna may be 144 Mbps.

Referring to FIG. 2B, the access point 201 may include a plurality of antennas, and may be connected to the plurality of electronic devices 203, 205, and 207. When the access point 201 performs wireless communication with electronic devices based on the MU-MIMO mode, the access point 201 may distribute an antenna resource or a radio spatial resource to each of the plurality of electronic devices 203, 205, and 207 according to an antenna allocation scheduling method. Accordingly, the access point 201 may transmit many spatial streams in parallel to many clients, and thus, total network performance may be improved.

When wireless communication is performed based on the MU-MIMO mode, the electronic device 203 may transmit/receive data to/from the access point 201 through an antenna resource or a radio spatial resource distributed by the access point 201. Also, other electronic devices 205 and 207 may respectively transmit/receive different data in parallel with the electronic device 203 through a distributed antenna resource or radio spatial resource.

Referring to FIG. 3B, for example, the access point 201 may distribute and transmit a spatial stream formed in a plurality of antennas to multiple users, that is, electronic devices 203, 205, and 207. For example, when the access point 201 may simultaneously support a maximum of three spatial streams through three antennas, the transmission data rate (e.g., 1299 Mbps) indicating the maximum physical link speed may be provided, and a data transmission rate that each electronic device may obtain may be, for example, 433 Mbps, through a single antenna.

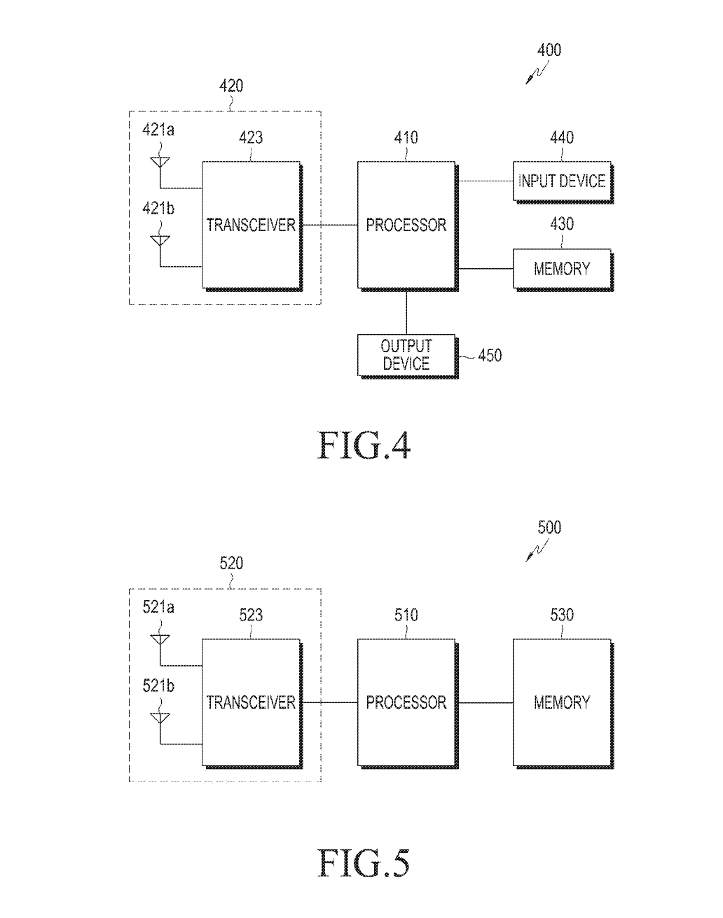

FIG. 4 illustrates an example of a configuration of an electronic device according to embodiments of the present disclosure.

Referring to FIG. 4, an electronic device 400 (electronic device 101 of FIG. 1 or the electronic device 203 of FIG. 2) may include a processor 410, a communication module 420, a memory 430, an input device 440, and an output device 450.

The processor 410 (processor 120 of FIG. 1) may process information associated with an operation of the electronic device 400 or information associated with the execution of a program, an application, or a function.

The processor 410 may perform a control to connect to an access point on a wireless communication network through a short range wireless communication scheme, for example, Wi-Fi, and transmit/receive data.

The processor 410 may perform a control to support a mode for supporting MU-MIMO and a mode for supporting SU-MIMO, for performing wireless data communication with the access point, and may switch a mode according to a wireless data communication condition with the access point. The processor 410 may determine whether to switch a mode in which multiple users currently access, to another mode, based on information obtained during wireless data communication in the state of being connected based on one of the mode for supporting the MU-MIMO and the mode for supporting the SU-MIMO. The processor 410 may perform a mode switching operation for performing wireless data communication with the access point, according to the determination.

The processor 410 may perform a connection procedure to initially establish a connection based on the MU-MIMO when the connection to the access point is established, and may perform wireless data communication with the access point based on the MU-MIMO mode when connection to the access point is established as the connection procedure is performed. The processor 410 may also perform a connection procedure to initially establish a connection based on the SU-MIMO mode when the connection to the access point is established.

In the state in which wireless data communication is performed based on MU-MIMO, the processor 410 may determine whether to switch the mode to SU-MIMO based on the information obtained through the wireless data communication. When the electronic device 400 is switched to SU-MIMO, a connection related message including information indicating that the mode is switched to the SU-MIMO mode may be transmitted to the access point. Accordingly, when the electronic device 400 is connected to the access point, the processor 410 may perform a control to perform wireless data communication with the access point based on SU-MIMO. Here, the connection related message may be at least one of a re-connection request message for re-connecting with an access point based on the SU-MIMO mode in the state in which the electronic device is connected to the access point; an action frame message transmitted in the state in which the electronic device is connected to the access point; and a connection request message that requests a connection in the state in which the electronic device is disconnected from the access point.

The processor 410 may obtain information to be used for mode switching through wireless data communication or through a message (e.g., a beacon message or a probe response message) received from an access point during access point search. For example, the information that may be obtained through the wireless communication for mode switching may include information obtained by determining a channel performance state (e.g., current data throughput information indicating a data transmission rate (data rate) during actual data communication) and information obtained through a feedback message received from an access point (e.g., information associated with the number of electronic devices connected to an access point and/or scheduling information allocated by an access point (e.g., the number of antennas or information associated with beamforming)).

The processor 410 may monitor a data transmission rate during the wireless data communication with the access point while in the MU-MIMO mode. Here, the processor 410 may determine the number of electronic devices connected to the access point, based on information for mode switching obtained when performing wireless data communication with the access point based on the MU-MIMO mode or searching for an access point. When the number of electronic devices connected to the access point is 1, the processor 410 may determine that only the electronic device 400 is connected to the access point, and may switch the current mode to the SU-MIMO mode. Also, the processor 410 may compare the maximum data transmission rate determined while being connected based on the MU-MIMO mode, with a set first maximum data transmission rate (e.g., the maximum data transmission rate set for the SU-MIMO mode). Here, the determined maximum data transmission rate may be determined based on a data transmission rate measured during the current wireless communication or information associated with the number of allocated antennas of an access point. When the comparison shows that the maximum data transmission rate currently determined in the MU-MIMO mode is less than the set first maximum data transmission rate, the processor 410 may switch the mode to the SU-MIMO mode.

The processor 410 may determine the number of antennas that the access point allocates to the electronic device 400 based on the determined maximum data transmission rate. Accordingly, the processor 410 may activate at least one of the antennas based on the number of antennas of the access point allocated to the electronic device 400, and may transmit/receive a data stream based on an SU-MIMO mode support protocol through the activated at least one antenna and the allocated antenna of the access point. Also, when the number of electronic devices connected to the access point is 1 (that is, when only the electronic device 400 is connected to the access point) and when the performance of wireless data communication based on the MU-MIMO mode is lower than the performance of data communication based on the SU-MIMO mode, the processor 410 may switch a mode to the SU-MIMO mode. The performance of the wireless data communication may be determined based on information of at least one of the performance of an antenna activated in the electronic device 400, the performance of an allocated antenna of the access point, and a channel performance (e.g., a data transmission rate).

When the mode is switched to the SU-MIMO mode, the processor 410 may generate, as the connection related message, a re-connection request message or an action frame request message including information indicating that the MU-MIMO mode is not supported (without MU-Beam former/formee capability). Here, the re-connection request message or the action frame request message may include a related field (e.g., MU-Beam former/formee capability field) of the MU-MIMO mode indicating whether the MU-MIMO mode is supported. The information indicating that the MU-MIMO mode is not supported (without MU-Beam former/formee capability) may be set in the related field of the MU-MIMO mode.

The processor 410 may transmit the generated re-connection request message or the action frame request message to the access point when the electronic device 400 is connected to the access point. Also, when the electronic device 400 is switched to the SU-MIMO mode, the processor 410 may perform a control to disconnect a wireless communication connection with the access point, and may generate, as the connection related message, a connection request message including a mode support related field (beamformer/formee capability field) indicating whether the MU-MIMO mode is supported, which is set as information indicating that the MU-MIMO mode is not supported. The processor 410 may transmit the generated connection request message to the access point, and may perform a connection procedure with the access point. According to another embodiment of the present disclosure, the processor 410 may determine whether to switch a mode to the MU-MIMO mode based on information for mode switching obtained while connected to the access point based on the SU-MIMO mode. Here, the processor 410 may determine the number of electronic devices connected to the access point, based on information for mode switching obtained when performing wireless data communication with the access point based on the SU-MIMO mode. When the number of electronic devices connected to the access point is greater than or equal to 2, the processor 410 may switch a current mode from the SU-MIMO mode to the MU-MIMO mode. Also, the processor 410 may monitor information (e.g., a data transmission rate) associated with a channel performance state determined when wireless data communication with the access point is performed based on the SU-MIMO mode. When a data transmission rate determined during the current wireless data communication (e.g., a real-time data transmission rate or the maximum data transmission rate measured based on data transmission rates determined during a predetermined period of time) is less than a set second maximum data transmission rate (e.g., a set maximum data transmission rate of the MU-MIMO mode), the processor 410 may switch the current mode to the MU-MIMO mode.

According to another embodiment of the present disclosure, when the electronic device 400 is switched to the MU-MIMO mode, the processor 410 may transmit a connection related message including information indicating that the electronic device 400 is switched to the MU-MIMO mode. When the electronic device 400 is connected to the access point, the processor 410 may perform a control to transmit/receive a data stream to/from the access point through at least one activated antenna based on the MU-MIMO mode. For example, when the mode is switched to the MU-MIMO mode, the processor 410 may generate, as the connection related message, a re-connection request message or an action frame request message including a field that is set as information (e.g., “1”) indicating that the MU-MIMO mode is supported (e.g. MU-Beam former/formee performance is supported). Here, the field may be a field related to the MU-MIMO mode, and may be a field indicating whether the MU-MIMO mode is supported (e.g., MU-Beam former/formee capability field). The processor 410 may transmit the generated re-connection request message or the action frame request message when the electronic device 400 is connected to the AP. Also, for example, when the electronic device 400 is switched to the MU-MIMO mode, the processor 410 may perform a control to disconnect a wireless communication connection with the access point, and may generate, as the connection related message, a connection request message including a related field (MU-Beam former/formee capability field) indicating whether the MU-MIMO mode is supported, which is set as information (e.g., “1”) indicating that the MU-MIMO mode is supported. The processor 410 may transmit the generated connection request message to the access point, and may perform a control to connect with the access point.

According to various embodiments, the processor 410 may be a hardware module or a software module (e.g., an application program), and may be a hardware element (function) or a software element (program) including at least one of various sensors, a data measuring module, an input/output interface, a module for managing a state or an environment of the electronic device 400, and a communication module included in the electronic device 400.

The communication module 420 (e.g., the communication interface 170 of FIG. 1) of the electronic device 400 may perform communication with an access point on a wireless communication network, or another electronic device, according to the control of the processor 410. The communication module 420 may transmit/receive, to/from an access point or another electronic device, data related to operations executed according to the control of the processor 410. The communication module 420 may perform communication through a connection to a network or a connection between devices through a communication interface using wireless communication or wired communication. The wireless communication may include, for example, at least one of Wi-Fi, BT, Zigbee, z-wave, NFC, global GPS and cellular communication (e.g., LTE, LTE-A, CDMA, WCDMA, UMTS, WiBro, GSM or the like). The wired communication may include, for example, at least one of USB, HDMI, RS-232, POTS, universal asynchronous receiver transmitter (UART), inter-integrated circuit (I2C), serial peripheral interface (SPI), and a controller area network (CAN). Also, the communication module 420 may include all types of communication schemes which have been publicly known or which are to be developed, in addition to the above described communication schemes.

The communication module 420 may perform wireless data communication with an access point through, for example, a wireless communication network (e.g., Wi-Fi), and may include a plurality of antennas 421a and 421b, a transceiver 423, and a wireless signal processing module (a filter, an amplifier, a noise eliminator, an analog/digital converter, an encoder, a decoder, and the like). When receiving a control signal from the processor 410 during mode switching, the communication module 420 may activate at least one antenna according to a switched mode (MU-MIMO mode or SU-MIMO mode), and may transmit a data stream or a connection related message transferred from the processor 410 through the at least one activated antenna to the access point through an allocated antenna of the access point, or transfer, to the processor 410, a message (connection related response message) or a data stream received from the access point through the at least one activated antenna.

A The memory 430 of the electronic device 400 may temporarily store a program required for operating a function and various data generated while a program is executed. The memory 430 may briefly include a program area and a data area. The program area may store information associated with driving the electronic device 400, such as an operating system (OS) that boots up the electronic device 400. The data area may store data transmitted/received and generated data. Also, the memory 430 may include at least one storage medium including a flash memory, a hard disk, a multimedia card micro type memory (e.g., an SD or XD memory), a RAM, and a ROM. The memory 430 may store information for communication with an access point or another electronic device, and transmitted/received data.

The input device 440 (e.g., the input/output interface 150 of FIG. 1) of the electronic device 400 may transfer, to the processor 410, various information of numbers and characters input by a user, and a signal input in association with setting various functions and controlling functions of the electronic device 400. Also, the input device 440 may support a user input for executing a module or an application that supports a predetermined function. The input device 440 may include at least one of a key input means, such as a keyboard or a keypad, a touch input means such as a touch sensor or a touch pad, a sound source input means, a camera, and various sensors, and may further include a gesture input means. In addition, the input unit 440 may include all types of input means, which are currently developed or will be developed in the future. The input device 440 may receive information input by a user through a touch panel of a display or a camera, and may transfer the input information to the processor 410. The input device 440 may receive, from a user through a sound source input means (e.g., a microphone), an input signal associated with data to be transferred to another electronic device, and may transfer the input signal to the processor 410.

The output device 450 of the electronic device 400 may include a display or an audio module such as output interface 150 of FIG. 1. The electronic device 400 may further include a vibration output means or a scent output means. The vibration output means or the scent output means may output, as a vibration or scent, at least one of data transmitted/received through wireless data communication, a notification event generated as the data is transmitted/received, and information associated with the generated notification event.

As described above, embodiments of the present disclosure have described the main elements of an electronic device through the electronic device 400 of FIG. 4. However, the elements of FIG. 4 are not prerequisite, and an electronic device may include fewer or more elements when compared to the elements of FIG. 4. Also, the locations of the main elements of the electronic device described through FIG. 4 may be changed according to a device design.

An electronic device may include a communication module that performs wireless data communication with an access point, and may also include a processor. The processor performs obtaining information for mode switching in a state in which an electronic device is connected to the access point based on a first mode from among a multiple user multiple input multiple output (MU-MIMO) mode and a single-user multiple input multiple output (SU-MIMO) mode; determining whether to switch the mode into a second mode, which is different from the first mode, from among the MU-MIMO mode and the SU-MIMO mode, based on the obtained information for mode switching; and performing wireless data communication with the access point based on the switched second mode when the electronic device is switched to the second mode according to the determination.

When the first mode is the MU-MIMO mode and the second mode is the SU-MIMO mode, the processor may further perform determining the number of electronic devices connected to the access point based on the information for mode switching obtained in the state in which the electronic device is connected to the access point based on the MU-MIMO mode; and when the number of electronic devices connected to the access point is 1, switching the MU-MIMO mode to the SU-MIMO mode.

When the first mode is the MU-MIMO mode and the second mode is the SU-MIMO mode, the processor further may perform obtaining a maximum data transmission rate determined in the MU-MIMO mode as the information for mode switching; and when the obtained maximum data transmission rate is less than a maximum data transmission rate set for the SU-MIMO mode, switching the MU-MIMO mode to the SU-MIMO mode.

The processor may further perform determining the number of antennas that the access point allocates to the electronic device, based on the obtained maximum data transmission rate; and activating at least one of the antennas based on the number of antennas of the access point allocated to the electronic device.

When the first mode is the SU-MIMO mode and the second mode is the MU-MIMO mode, the processor may further perform obtaining, as the information for mode switching, a current data transmission rate determined through an execution of wireless data communication with the access point in the SU-MIMO mode; and when the determined current data transmission rate is less than a maximum data transmission rate set for the MU-MIMO mode, switching the SU-MIMO mode to the MU-MIMO mode.

When the first mode is the SU-MIMO mode and the second mode is the MU-MIMO mode, the processor may further perform determining the number of electronic devices connected to the access point based on the obtained information for mode switching; and when the number of electronic devices connected to the access point is greater than or equal to 2, switching the SU-MIMO mode to the MU-MIMO mode.

The processor may perform transmitting a connection related message including information indicating that the electronic device is switched to the second mode when the mode is switched to the second mode; and performing a control to perform wireless data communication with the access point based on the second mode when being connected to the access point based on the second mode.

State information may include at least one of the number of electronic devices connected to the access point, a maximum data transmission rate allocated to the electronic device, and current data throughput information determined in the electronic device.

The processor may further perform when the mode is switched to the SU-MIMO mode as the second mode, generating, as the connection related message, a re-connection request message or an action frame request message including a related field indicating whether the MU-MIMO mode is supported, in which information indicating that the MU-MIMO mode is not supported is set; and transmitting the generated re-connection request message or action frame request message in the state in which the electronic device is connected to the access point.

The processor may further perform executing a control to disconnect a wireless communication connection with the access point when the electronic device is switched to the SU-MIMO mode; generating, as the connection related message, a connection request message including a MU-MIMO mode related field, which is set as information indicating that the MU-MIMO mode is not supported; and transmitting the generated connection request message to the access point.

FIG. 5 is a diagram illustrating an example of a configuration of an access point according to embodiments of the present disclosure.

Referring to FIG. 5, according to embodiments of the present disclosure, an access point 500 may include a processor 510, a communication module 520, and a memory 530.

The processor 510 may process information associated with an operation of the access point 500 or information associated with the execution of a program, an application, or a function.

The processor 510 may perform a control to execute wireless data communication with at least one electronic device such as the electronic device 101 of FIG. 1, the electronic device 203, 205, and 207 of FIG. 2, or the electronic device 400 of FIG. 4 through a wireless communication network. Also, the processor 510 may serve as a wireless hub so as to connect with at least one electronic device on a wireless communication network (e.g., a Wi-Fi communication network).

The processor 510 may control the access point 500 to operate based on a mode for supporting MU-MIMO and a mode for supporting SU-MIMO, so as to perform wireless data communication with at least one electronic device. The processor 510 may perform a connection procedure so that the electronic device is connected to the wireless communication network. Here, when the electronic device is initially connected and the electronic device supports MU-MIMO, the processor 510 performs scheduling to distribute antennas based on MU-MIMO, and distributes an antenna resource to all of the currently connected electronic devices. Accordingly, the processor 510 may perform a control to connect to the electronic device based on the MU-MIMO mode through the antennas distributed to the electronic device, and to transmit/receive a data stream.

The processor 510 may transmit, to the electronic device, information associated with the number of electronic devices connected to the access point, using at least one of a message (e.g., a beacon message or a probe response message) for searching for the access point 500, a message transmitted/received during a connection procedure, and a message transmitted/received during wireless data communication. Also, the processor 510 may transmit information associated with a result of scheduling for antenna allocation (e.g., information associated with the number of allocated antennas, channel performance information, and the like) to the electronic device through at least one of a message transmitted/received during a connection procedure and a message transmitted/received during wireless data communication.

In addition, at least a part of a configuration of the processor 510 of the access point 500 may include at least one processor including a central processing unit (CPU)/micro processing unit (MPU), a memory to which at least one memory loading data is loaded (e.g., a register and/or random access memory (RAM)), and a bus that inputs/outputs at least one piece of data to the processor and the memory, from the perspective of hardware. Also, the processor 510 may be configured to include a predetermined program routine or program data, which is calculated and processed after being loaded from a predetermined recording medium to the memory 530, so as to execute a function defined in an electronic device, from the perspective of software.

The communication module 520 of the access point 500 may perform communication with at least one electronic device such as the electronic device 101, 102, or 104 of FIG. 1, the server 106, the electronic device 203, 205, or 207 of FIG. 2, or the electronic device 400 of FIG. 4 connected to a wireless communication network according to the control of the processor 510. The communication module 520 may transmit/receive, to/from an electronic device, data related to operations executed according to the control of the processor 510. The communication module 520 may perform communication through a connection with an electronic device, using wireless communication through a communication interface. The wireless communication may include at least one of, for example, Wi-Fi, BT, Zigbee, z-wave, NFC, GPS and cellular communication (e.g., LTE, LTE-A, CDMA, WCDMA, UMTS, WiBro, GSM or the like). Also, the communication module 520 may include all types of communication schemes which have been publicly known or which are to be developed, in addition to the above described communication schemes.

The communication module 520 may perform wireless data communication with at least one electronic device connected through, for example, a wireless communication network (e.g., Wi-Fi), and may include a plurality of antennas 521a and 521b, a transceiver 523, and a wireless signal processing module (a filter, an amplifier, a noise eliminator, an analog/digital converter, an encoder, a decoder, and the like). When a control signal is received from the processor 510 during mode switching, the communication module 520 may activate at least one antenna distributed or allocated according to a switched mode (MU-MIMO mode or SU-MIMO mode) of the connected electronic device, and may transmit a data stream or a message (e.g., a connection related response message) transferred from the processor 510 through the at least one activated antenna, or may transfer, to the processor 510, a message (e.g., a connection related message) or a data stream received from an electronic device through the at least one activated antenna.

The memory 530 of the access point 500 may temporarily store a program required for operating a function and various data generated while a program is executed. The memory 530 may briefly include a program area and a data area. The program area may store information associated with driving the access point 500, such as an operating system (OS) that boots up the access point 500. The data area may store data transmitted/received, and may store generated data. Further, the storage unit 530 may include at least one storage medium from among a flash memory, a hard disk, a multimedia card micro type memory (e.g., an SD or XD memory), a RAM, and a ROM. The memory 530 may also store information for communication with at least one connected electronic device and transmitted/received data.

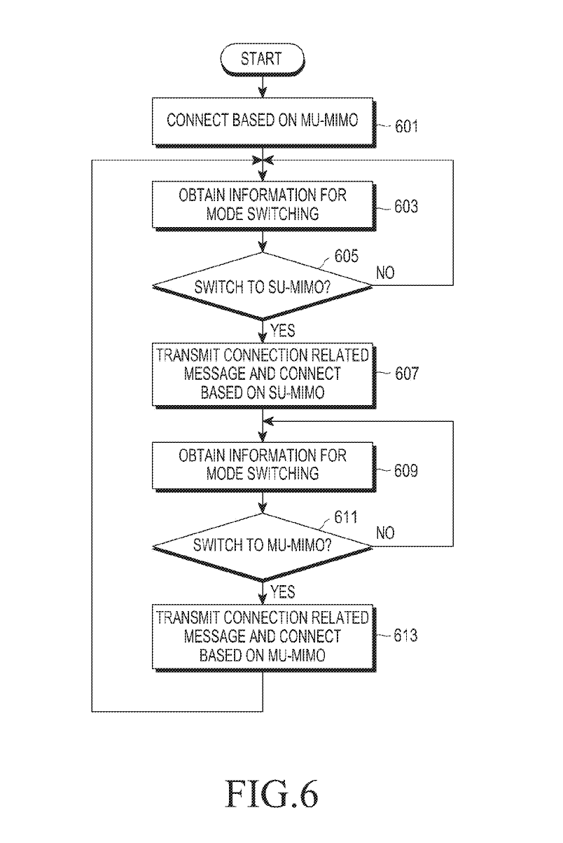

FIG. 6 illustrates a flowchart of an operation procedure of the electronic device according to an embodiment of the present disclosure.

Referring to FIG. 6, an electronic device may search for an access point for connection to a wireless communication network (e.g., Wi-Fi).

In step 601, the electronic device performs a connection procedure to connect with an access point selected from retrieved access points. When the selected access point is connected, the electronic device determines whether the connected access point supports MU-MIMO. When the determination shows that the connected access point supports MU-MIMO, the electronic device transmits/receives a data stream to/from the access point through wireless data communication on the MU-MIMO mode.

In step 603, the electronic device obtains information for mode switching. Here, the electronic device may obtain information for mode switching using a message received from the selected access point during searching (e.g., a beacon message or a probe response message), a message received during the connection procedure with the selected access point, or a message received during the transmission/reception of a data stream or determined channel performance information.

In step 605, the electronic device determines whether to switch the current mode to the SU-MIMO mode based on the obtained information for mode switching. Here, to determine mode switching, for example, the electronic device determines the number of electronic devices connected to the access point, and determines to switch the mode to the SU-MIMO mode when the number of electronic devices connected to the access point is 1. Also, as another example, when the electronic device is connected to the access point based on the MU-MIMO mode, the electronic device obtains, as the information for mode switching, the maximum data transmission rate determined by the allocation of an access point antenna, and determines to switch the mode to the SU-MIMO mode when the obtained maximum data transmission rate is less than a set first maximum data transmission rate (e.g., the maximum data transmission rate set for the SU-MIMO mode). Also, the electronic device may determine a data throughput (e.g., a current data throughput) by wireless data communication based on the currently allocated channel performance information, and may determine whether to switch the mode based on the determined data throughput.

In step 607, when the electronic device determines to switch the mode to SU-MIMO, the electronic device switches the mode to SU-MIMO, and reports, to the access point, that the mode is switched to the SU-MIMO mode. In this instance, the electronic device may transmit, to the access point, a connection related message including information indicating that the mode is switched to the SU-MIMO mode. Here, the electronic device may determine the number of antennas that the access point allocates to the electronic device based on the obtained maximum data transmission rate, and may activate at least one of the antennas based on the number of antennas of the access point allocated to the electronic device.

In step 607, according to an embodiment of the present disclosure, the electronic device may generate, as the connection related message, a re-connection request message or an action frame request message including a related field (e.g., MU-Beam former/formee capability field) of the MU-MIMO mode, which is set as information indicating that the MU-MIMO mode is not supported (without MU-Beam former/formee capability), and may transmit the generated re-connection request message or the action frame request message. The electronic device may also generate, as the connection related message, a connection request message including a related field (e.g., MU-Beam former/formee capability field) of the MU-MIMO, which is set as information indicating that the MU-MIMO mode is not supported, may disconnect a connection with the access point, may transmit the generated connection request message to the access point, and may perform a connection procedure with the access point.

In step 609, the electronic device connects with the access point based on the SU-MIMO mode, transmits/receives a data stream, and obtains information for mode switching during the transmission/reception of a data stream.

In step 611, the electronic device determines whether to switch the current SU-MIMO mode to the MU-MIMO mode based on the obtained information. Here, to determine mode switching, for example, the electronic device determines the number of electronic devices connected to the access point, and determines to switch the mode to the MU-MIMO mode when the number of electronic devices connected to the access point is greater than or equal to 2. Also, as another example, the electronic device determines a current data transmission rate during the execution of wireless data communication with the access point based on the SU-MIMO mode, and obtains the determined current data transmission rate as information for mode switching. When the obtained current data transmission rate is less than a set second maximum data transmission rate (e.g., the maximum data transmission rate set for the MU-MIMO mode), the electronic device may determine to switch the mode to the MU-MIMO mode.

In step 613, when the electronic device determines to switch the mode to MU-MIMO, the electronic device switches the mode to MU-MIMO, and reports, to the access point, that the mode is switched to the MU-MIMO mode. In this instance, the electronic device may transmit, to the access point, a connection related message including information indicating that the mode is switched to the MU-MIMO mode. Here, the electronic device may determine the number of antennas that the access point allocates to the electronic device based on the current data transmission rate, and may activate at least one of the antennas based on the number of antennas of the access point allocated to the electronic device.

In step 613, according to an embodiment of the present disclosure, the electronic device may generate, as the connection related message, a re-connection request message or an action frame request message including a related field (e.g., MU-Beam former/formee capability field) of the MU-MIMO mode, which is set as information indicating that the MU-MIMO mode is supported (MU-Beam former/formee capability), and may transmit the generated re-connection request message or the action frame request message. The electronic device may also generate, as the connection related message, a connection request message including a related field (e.g., MU-Beam former/formee capability field) of the MU-MIMO, which is set as information indicating that the MU-MIMO mode is supported, may disconnect a connection with the access point, may transmit the generated connection request message to the access point, and may perform a connection procedure with the access point.

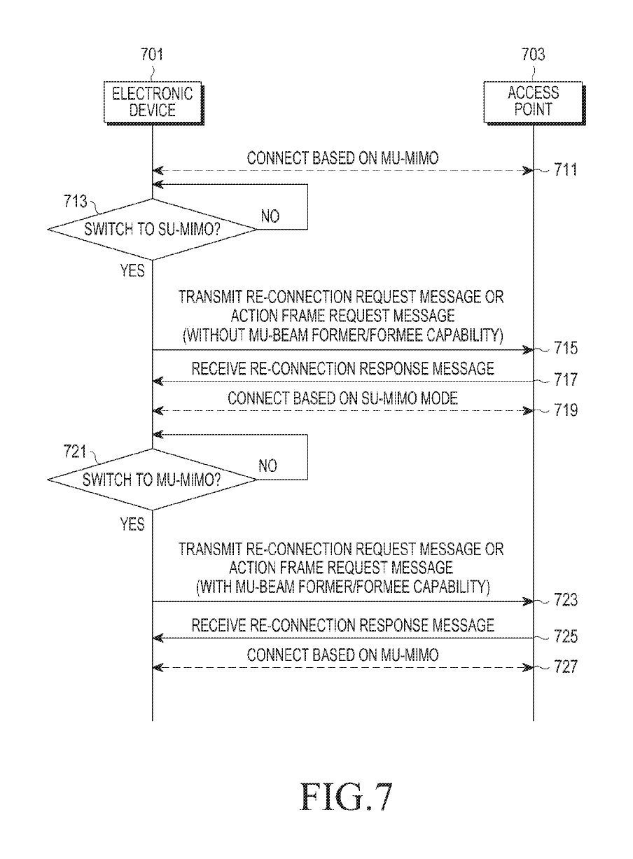

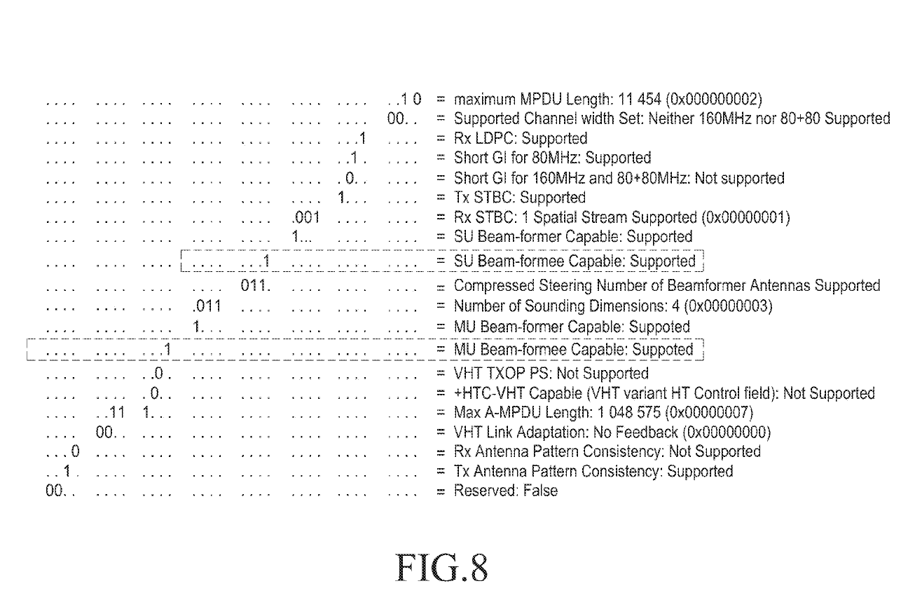

FIG. 7 is a flow diagram illustrating a wireless communication method between an electronic device and an access point according to embodiments of the present disclosure. FIG. 8 illustrates an example of a protocol including information indicating that multiple user multiple input multiple output (MU-MIMO) is supported according to embodiments of the present disclosure.

Referring to FIG. 7, an electronic device 701 may perform a connection procedure with an access point 703 that is selected through an access point search for the connection to a wireless communication network (e.g., Wi-Fi), in step 711. Also, the access point 703 supports the MU-MIMO mode, and thus, the electronic device 701 connects with the access point 703 based on the MU-MIMO mode at the initial connection, and performs wireless data communication. Accordingly, the electronic device 701 may obtain information for switching the mode to the SU-MIMO mode, using a message received from the selected access point 703 during searching (e.g., a beacon message or a probe response message), a message received during the connection procedure with the selected access point 703, or a message received during the transmission/reception of a data stream or determined channel performance information.

In step 713, when the electronic device 701 connects with the access point 703, the electronic device 701 determines whether to switch the current mode to another mode based on the obtained information for mode switching. Here, to determine mode switching, for example, the electronic device 701 determines the number of electronic devices connected to the access point 703, and determines to switch the mode to the SU-MIMO mode when the number of electronic devices connected to the access point 703 is 1. Also, as another example, the electronic device 701 obtains the maximum data transmission rate determined when the electronic device 701 connects with the access point 703 based on the MU-MIMO mode, and determines to switch the mode to the SU-MIMO mode when the obtained maximum data transmission rate is less than a set first maximum data transmission rate (e.g., the maximum data transmission rate set for the SU-MIMO mode).

In step 715, when the electronic device 701 determines to switch the mode to SU-MIMO, the electronic device 701 switches the mode to SU-MIMO, and reports, to the access point 703, that the mode is switched to the SU-MIMO mode. In this instance, the electronic device 701 may set a related field (e.g., MU-Beam former/formee capability field) of the MU-MIMO mode included in a MU-MIMO support protocol as illustrated in FIG. 8, as information (“0”) indicating that the MU-MIMO mode is not supported (e.g., without MU-Beam former/formee capability). The electronic device 701 may generate, as the connection related message, a re-connection request message or an action frame request including a related field (e.g., MU-Beam former/formee capability field) of the MU-MIMO mode, which is set as information (“0”) indicating that the MU-MIMO mode is not supported (e.g., without MU-Beam former/formee capability).

In step 715, the electronic device 701 transmits the generated re-connection request message or the action frame request message to the access point 703. Accordingly, the access point 703 determines information set in the related field (e.g., MU-Beam former/formee capability field) of the MU-MIMO mode included in the received re-connection request message or the action frame request message, determines that the electronic device 701 currently does not support the MU-MIMO mode (that is, recognizes that the mode is switched to the SU-MIMO mode), and performs an antenna resource allocation operation according to the SU-MIMO mode. Here, since the electronic device 701 is in the SU-MIMO mode (that is, currently, only the electronic device 701 is connected), the access point 703 may allocate all antenna resources to the electronic device 701, and may transmit a re-connection response message including information indicating whether re-connection with the electronic device 701 based on the SU-MIMO mode is allowed.

In step 717, the electronic device 701 receives, from the access point 703, a re-connection response message associated with a re-connection operation. Here, when the electronic device 701 determines that re-connection with the access point 703 based on the SU-MIMO mode is allowed based on the re-connection response message, the electronic device 701 performs an operation for re-connecting with the access point 703.

In step 719, the electronic device 701 is connected to the access point 703 based on the SU-MIMO mode, and performs wireless data communication based on the SU-MIMO mode. In this instance, the electronic device 701 may obtain information for mode switching during the wireless data communication as described in step 711.

In step 721, the electronic device 701 determines whether to switch the current SU-MIMO mode to the MU-MIMO mode. Here, to determine mode switching, for example, the electronic device 701 determines the number of electronic devices connected to the access point 703, and determines to switch the mode to the MU-MIMO mode when the number of electronic devices connected to the access point 703 is greater than or equal to 2. Also, as another example, the electronic device may monitor a data transmission rate during the execution of wireless data communication with the access point based on the SU-MIMO mode, may obtain a current data transmission rate determined through monitoring as information for mode switching, and may determine to switch the mode to the MU-MIMO mode when the obtained current data transmission rate is less than a set second maximum data transmission rate (e.g., the maximum data transmission rate set for the MU-MIMO mode). In this instance, the electronic device 701 may set a related field (e.g., MU-Beam former/formee capability field) of the MU-MIMO mode included in a MU-MIMO support protocol as illustrated in FIG. 8, as information (“1”) indicating that the MU-MIMO mode is supported (e.g., with MU-Beam former/formee capability). The electronic device 701 may generate, as the connection related message, a re-connection request message or an action frame request including the related field (e.g., MU-Beam former/formee capability field) of the MU-MIMO mode, which is set as information (“1”) indicating that the MU-MIMO mode is supported (e.g., with MU-Beam former/formee capability).

In step 723, the electronic device 701 transmits the generated re-connection request message or the action frame request message (e.g., with MU-Beam former/formee capability information) to the access point 703. Accordingly, the access point 703 determines information set in the related field (e.g., MU-Beam former/formee capability field) of the MU-MIMO mode included in the received re-connection request message or the action frame request message, determines that the electronic device 701 currently supports the MU-MIMO mode (that is, recognizes that the mode is switched to the MU-MIMO mode), and performs an antenna resource allocation operation according to the MU-MIMO mode. Here, since the electronic device 701 is in the MU-MIMO mode (that is, other electronic devices in addition to the electronic device 701 are currently connected), the access point 703 may distribute an antenna resource to the electronic device 701, and may perform an operation for re-connecting with the electronic device 701 based on the MU-MIMO mode.

In step 725, the electronic device 701 receives, from the access point 703, a re-connection response message associated with a re-connection operation.

In step 727, the electronic device 701 connects with the access point 703 based on the MU-MIMO mode, and performs wireless data communication based on the MU-MIMO mode. In this instance, the electronic device 701 may obtain information for mode switching during the wireless data communication as described in step 711.

The electronic device 701 may repeat the operation procedure of FIG. 7 until the communication with the access point 703 is completely terminated.

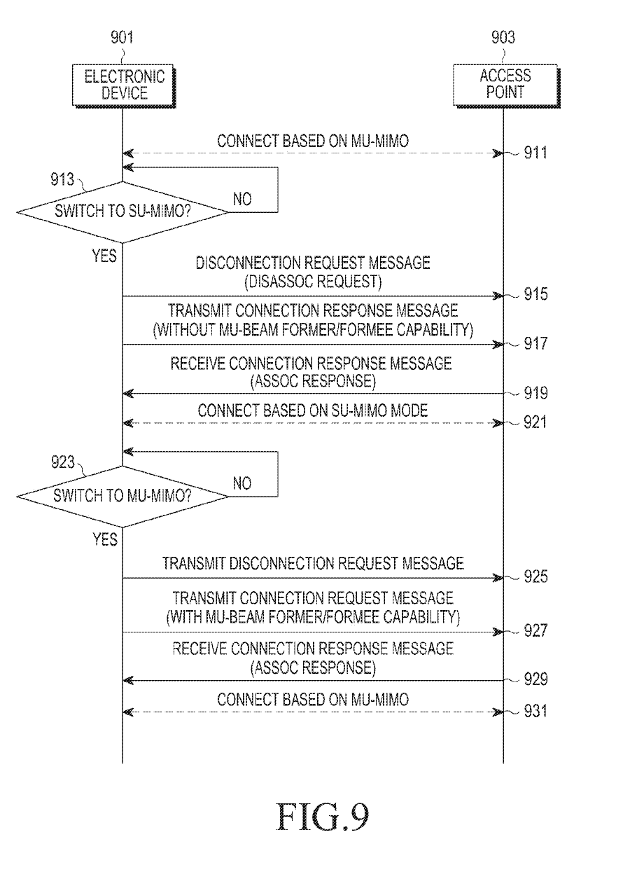

FIG. 9 is a flow diagram illustrating a wireless communication method between an electronic device and an access point according to embodiments of the present disclosure.

Referring to FIG. 9, an electronic device 901 may perform a connection procedure with an access point 903 that is selected through an access point search for the connection to a wireless communication network (e.g., Wi-Fi), in step 911. Also, the access point 903 supports the MU-MIMO mode, and thus, the electronic device 901 connects with the access point 903 based on the MU-MIMO mode at the initial connection, and performs wireless data communication. Accordingly, the electronic device 901 may obtain information for switching the method to the SU-MIMO mode using a message received from the selected access point 903 during searching (e.g., a beacon message or a probe response message), a message received during the connection procedure with the selected access point 903, or a message received during the transmission/reception of a data stream or determined channel performance information.

In step 913, when the electronic device 901 is connected to the access point 903, the electronic device 901 determines whether to switch the current mode to another mode based on the obtained information for mode switching. Here, to determine mode switching, for example, the electronic device 901 determines the number of electronic devices connected to the access point 903, and determines to switch the mode to the SU-MIMO mode when the number of electronic devices connected to the access point 903 is 1. Also, as another example, the electronic device 901 obtains the maximum data transmission rate determined when the electronic device 901 connects with the access point 903 based on the MU-MIMO mode, and determines to switch the mode to the SU-MIMO mode when the obtained maximum data transmission rate is less than a set first maximum data transmission rate (e.g., the maximum data transmission rate set for the SU-MIMO mode).

In step 915, when it is determined to switch the mode to the SU-MIMO mode, the electronic device 901 switches the mode to the SU-MIMO mode, and transmits a disconnection request message (disassoc Request) to the access point 903 to disconnect the connection with the access point 903.

In step 917, the electronic device 901 reports, to the access point 903, that the mode is switched to the SU-MIMO mode, and transmits a connection request message for performing a connection procedure with the access point 903. In this instance, the electronic device 901 may set a related field (e.g., MU-Beam former/formee capability field) of the MU-MIMO mode included in a MU-MIMO support protocol as illustrated in FIG. 8, as information (“0”) indicating that the MU-MIMO mode is not supported (e.g., without MU-Beam former/formee capability). The electronic device 901 may generate, as the connection related message, a connection request message including the related field (e.g., MU-Beam former/formee capability field) of the MU-MIMO mode, which is set as information (“0”) indicating that the MU-MIMO mode is not supported (e.g., without MU-Beam former/formee capability).

In step 917, the electronic device 901 transmits the generated connection request message to the access point 903. Accordingly, the access point 903 determines information set in the related field (e.g., MU-Beam former/formee capability field) of the MU-MIMO mode included in the received connection request message, determines that the electronic device 901 currently does not support the MU-MIMO mode (that is, recognizes that the mode is switched to the SU-MIMO mode), and performs an antenna resource allocation operation according to the SU-MIMO mode. Here, since the electronic device 901 is in the SU-MIMO mode (that is, only the electronic device 901 is currently connected), the access point 903 may allocate all antenna resources to the electronic device 901, and may perform a connection procedure for the connection to the electronic device 901 based on the SU-MIMO mode.

In step 919, the electronic device 701 receives a connection response message (assoc Response) from the access point 903.

In step 921, the electronic device 901 is currently disconnected from the access point 903, and thus, the electronic device 901 performs a connection procedure with the access point 903 again for connecting with the access point 903 based on the SU-MIMO mode. Subsequently, when the electronic device 901 connects with the access point 903 based on the SU-MIMO mode, the electronic device 901 may perform wireless data communication with the access point 903 based on the SU-MIMO mode. In this instance, the electronic device 901 may obtain information for mode switching during the wireless data communication as described in step 911.

In step 923, the electronic device 901 determines whether to switch the current SU-MIMO mode to the MU-MIMO mode. Here, to determine mode switching, for example, the electronic device 901 determines the number of electronic devices connected to the access point 903, and determines to switch the mode to the MU-MIMO mode when the number of electronic devices connected to the access point 903 is greater than or equal to 2. Also, as another example, the electronic device 901 determines a current data transmission rate during the execution of wireless data communication with the access point 903 based on the SU-MIMO mode, obtains the determined current data transmission rate as information for mode switching, and determines to switch the mode to the MU-MIMO mode when the obtained current data transmission rate is less than a set second maximum data transmission rate (e.g., the maximum data transmission rate set for the MU-MIMO mode). In this instance, the electronic device 901 may set a related field (e.g., MU-Beam former/formee capability field) of the MU-MIMO mode included in a MU-MIMO support protocol as illustrated in FIG. 8, as information (“1”) indicating that the MU-MIMO mode is supported (e.g., with MU-Beam former/formee capability). The electronic device 901 may generate, as the connection related message, a re-connection request message or an action frame request message including a related field (e.g., MU-Beam former/formee capability field) of the MU-MIMO mode, which is set as information (“1”) indicating that the MU-MIMO mode is supported (e.g., with MU-Beam former/formee capability).

In step 925, when it is determined to switch the mode to the MU-MIMO mode, the electronic device 901 switches the mode to the MU-MIMO mode, and transmits a disconnection request message (disassoc Request) to the access point 903 to disconnect the connection with the access point 903.

In step 927, the electronic device 901 transmits the generated connection request message (with MU-Beam former/formee capability information). Accordingly, the access point 903 determines information set in the related field (e.g., MU-Beam former/formee capability field) of the MU-MIMO mode included in the received re-connection request message or the action frame request message, determines that the electronic device 901 currently supports the MU-MIMO mode (that is, recognizes that the mode is switched to the MU-MIMO mode), and performs an antenna resource allocation operation according to the MU-MIMO mode. Here, since the electronic device 901 is in the MU-MIMO mode (that is, other electronic devices in addition to the electronic device 901 are currently connected), the access point 903 may distribute an antenna resource to the electronic device 901, and may transmit a connection response message including information indicating whether connection to the electronic device 901 based on the MU-MIMO mode is allowed.

In step 929, the electronic device 901 receives a connection response message for executing a connection procedure from the access point 903.

In step 931, the electronic device 901 performs a connection procedure for connecting with the access point 903 based on the MU-MIMO mode. Subsequently, when the electronic device 901 connects with the access point 903 based on the MU-MIMO mode, the electronic device 901 may perform wireless data communication with the access point 903 based on the MU-MIMO mode. In this instance, the electronic device 901 may obtain information for mode switching during the wireless data communication as described in step 911.

The electronic device 901 may repeat the operation procedure of FIG. 9 until the communication with the access point 903 is completely terminated.

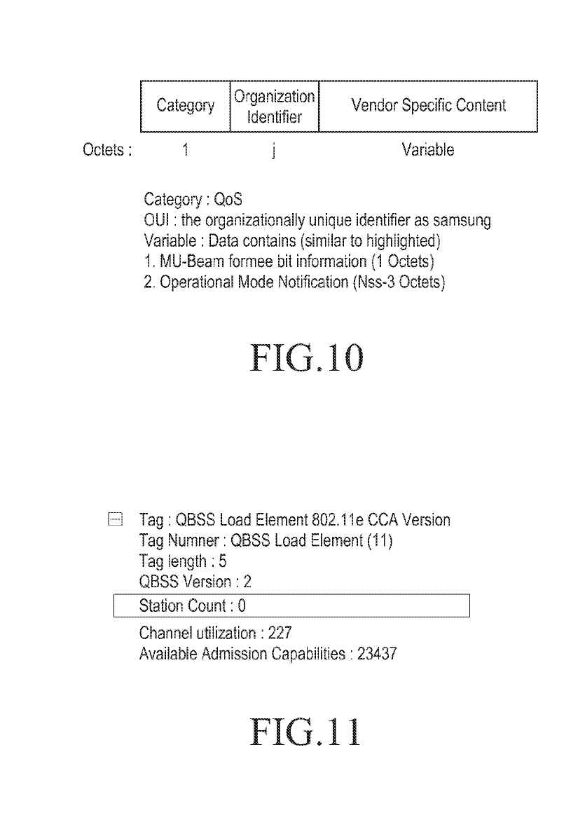

FIGS. 10 and 11 illustrate an example of a message transmitted/received between an electronic device and an access point according to embodiments of the present disclosure.

The message transmitted/received between an electronic device and an access point illustrated in FIG. 10 may be an example of an action frame request message transmitted in step 715 and step 723 in the operation procedure of FIG. 7. The electronic device may include information as shown in FIG. 10, in the action frame request message. Referring to FIG. 10, the electronic device sets, for example, to 1 Octet, information (e.g., MU-Beam formee bit information) indicating that the MU-MIMO mode is supported, in a category field.

A message transmitted/received between an electronic device and an access point illustrated in FIG. 11, may be an example of a message (e.g., a beacon message or a probe response message) received in an operation in which the electronic device searches for access points in the above described operation procedure of FIGS. 7 and 9. The electronic device may obtain information for mode switching through a message (e.g., a beacon message or a probe response message) received in an operation of searching for access points, that is, information associated with the number of electronic devices connected to an access point. Referring to FIG. 11, Referring to FIG. 11, the message (e.g., a beacon message or a probe response message) that the electronic device receives during the searching operation may include information (e.g., station count) associated with the number of electronic devices connected to the access point.

A wireless communication method of an electronic device according to embodiments of the present disclosure includes obtaining information for mode switching in a state in which the electronic device is connected to the access point based on a first mode from among a multiple user multiple input multiple output (MU-MIMO) mode and a single user multiple input multiple output (SU-MIMO) mode; determining whether to switch the mode to the second mode, which is different from the first mode, from among the MU-MIMO and the SU-MIMO, based on the obtained information for mode switching; and performing wireless data communication with the access point based on the switched second mode when the electronic device is switched to the second mode according to the determination.

The operation of determining whether to switch the mode to the second mode, which is different from the first mode, includes determining the number of electronic devices connected to the access point based on the information for mode switching obtained in the state in which the electronic device is connected to the access point based on the MU-MIMO when the first mode is the MU-MIMO and the second mode is SU-MIMO; and switching the MU-MIMO to the SU-MIMO when the number of electronic devices connected to the access point is 1.

The operation of determining whether to switch the mode to the second mode, which is different from the first mode includes obtaining, as the information for mode switching, a maximum data transmission rate determined in the MU-MIMO when the first mode is the MU-MIMO and the second mode is the SU-MIMO; comparing the obtained maximum data transmission rate and a maximum data transmission rate set for the MU-MIMO; and switching the MU-MIMO to the SU-MIMO when the obtained maximum data transmission rate is less than the maximum transmission data rate set for the MU-MIMO.

The operation of determining whether to switch the mode to the second mode, which is different from the first mode, includes determining the number of antennas that the access point allocates to the electronic device based on the obtained maximum data transmission rate; and activating at least one of the antennas based on the number of antennas of the access point allocated to the electronic device.

The operation of determining whether to switch the mode to the second mode, which is different from the first mode, includes obtaining, as the information for mode switching, a current data transmission rate determined during wireless data communication with the access point performed based on the SU-MIMO when the first mode is the SU-MIMO and the second mode is the MU-MIMO; comparing the obtained current data transmission rate and a maximum data transmission rate set for the SU-MIMO; and determining to switch the SU-MIMO to the MU-MIMO when the obtained current data transmission rate is less than the maximum data transmission rate set for the SU-MIMO.

The operation of determining whether to switch the mode to the second mode, which is different from the first mode, includes determining the number of electronic devices connected to the access point based on the obtained information for mode switching when the first mode is the SU-MIMO and the second mode is the MU-MIMO; and switching the SU-MIMO to the MU-MIMO when the number of electronic devices connected to the access point is greater than or equal to 2.

The method further includes transmitting a connection related message including information indicating that the electronic device is switched to the second mode when the electronic device is switched to the second mode; and performing wireless data communication with the access point based on the second mode when the electronic device is connected to the access point based on the second mode.

When the first mode is the SU-MIMO mode and the second mode is the MU-MIMO mode, the operation of transmitting the connection related message includes generating, as a connection related message, a re-connection request message or an action frame request message including a related field indicating whether the MU MIMO mode is supported, which is set as information indicating that the MU-MIMO is not supported, when the electronic device is switched to the SU-MIMO mode; and transmitting the generated re-connection request message or the action frame request message in a state in which the electronic device is connected to the access point.

The operation of transmitting the connection related message includes disconnecting a wireless communication connection with the access point when the electronic device is switched to the SU-MIMO mode as the second mode; generating, as the connection related message, a connection request message including a related field indicating whether the MU-MIMO mode is supported, which is set as information indicating that the MU-MIMO is not supported; and transmitting the generated connection request message to the access point.

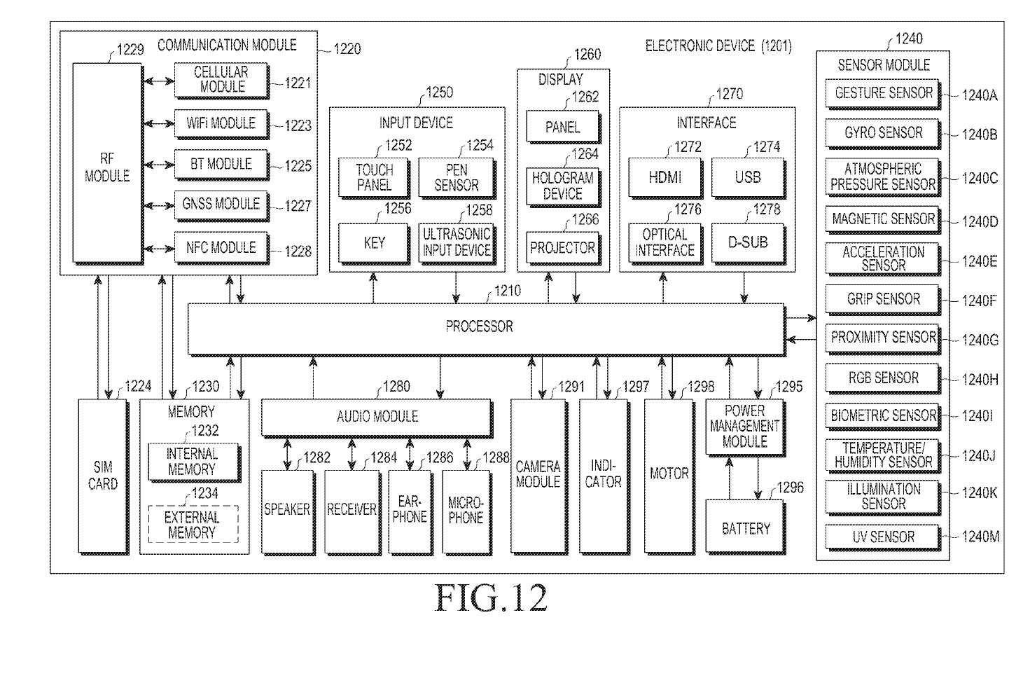

FIG. 12 is a block diagram of an electronic device according to embodiments of the present disclosure.

The electronic device 1201 may include, for example, the entirety or a part of the electronic device 101 illustrated in FIG. 1. The electronic device 1201 may include at least one processor 1210 (e.g., an AP), a communication module 1220, a subscriber identification module or SIM card 1224, a memory 1230, a sensor module 1240, an input device 1250, a display 1260, an interface 1270, an audio module 1280, a camera module 1291, a power management module 1295, a battery 1296, an indicator 1297, and a motor 1298. The processor 1210 may drive, for example, an operating system or application programs to control a plurality of hardware or software elements connected thereto and may perform various types of data processing and operations. The processor 1210 may be embodied, for example, as a system on chip (SoC). The processor 1210 may further include a graphic processing unit (GPU) and/or an image signal processor. The processor 1210 may also include at least some (e.g., a cellular module 1221) of the elements illustrated in FIG. 12. The processor 1210 may load, in a volatile memory, instructions or data received from at least one of the other elements (e.g., a non-volatile memory), process the loaded instructions or data, and store the resulting data in the non-volatile memory.

The communication module 1220 may have a configuration that is the same as, or similar to, that of the communication interface 170. The communication module 1220 may include, for example, the cellular module 1221, a Wi-Fi module 1223, a BT module 1225, a GNSS module 1227, an NFC module 1228, and an RF module 1229. The cellular module 1221 may provide, for example, a voice call, a video call, a text message service, an Internet service, or the like, through a communication network. The cellular module 1221 may identify and authenticate the electronic device 1201 within a communication network using the SIM card 1224. The cellular module 1221 may perform at least some of the functions that the processor 1210 may provide. The cellular module 1221 may include a communication processor (CP). At least some (two or more) of the cellular module 1221, the Wi-Fi module 1223, the BT module 1225, the GNSS module 1227, and the NFC module 1228 may be included in one Integrated Chip (IC) or IC package. The RF module 1229, for example, may transmit/receive a communication signal (e.g., an RF signal). The RF module 1229 may include, for example, a transceiver, a power amp module (PAM), a frequency filter, a low noise amplifier (LNA), an antenna, or the like. At least one of the cellular module 1221, the Wi-Fi module 1223, the BT module 1225, the GNSS module 1227, and the NFC module 1228 may transmit/receive an RF signal through a separate RF module. The SIM card 1224 may include, for example, a card that includes a subscriber identification module, or an embedded SIM, and may contain unique identification information (e.g., an integrated circuit card identifier (ICCID)) or subscriber information (e.g., international mobile subscriber identity (IMSI)).

The memory 1230 may include, for example, an embedded internal memory 1232 or an external memory 1234. The internal memory 1232 may include, for example, at least one of a volatile memory (e.g., a DRAM, an SRAM, an SDRAM, or the like) and a non-volatile memory (e.g., a one time programmable ROM (OTPROM), a PROM, an EPROM, an EEPROM, a mask ROM, a flash ROM, a flash memory, a hard disc drive, or a solid state drive (SSD)). The external memory 1234 may include a flash drive, for example, a compact flash (CF), a secure digital (SD), a Micro-SD, a Mini-SD, an eXtreme digital (xD), a multi-media card (MMC), a memory stick, or the like. The external memory 1234 may be functionally or physically connected to the electronic device 1201 through various interfaces.

The sensor module 1240 may, for example, measure a physical quantity or detect the operating state of the electronic device 1201 and may convert the measured or detected information into an electrical signal. The sensor module 1240 may include, for example, at least one of a gesture sensor 1240A, a gyro sensor 1240B, an atmospheric pressure sensor 1240C, a magnetic sensor 1240D, an acceleration sensor 1240E, a grip sensor 1240F, a proximity sensor 1240G, a color sensor 1240H (e.g., a red, green, blue (RGB) sensor), a biometric sensor 1240I, a temperature/humidity sensor 1240J, an illuminance sensor 1240K, and an ultraviolet (UV) sensor 1240M. Additionally or alternatively, the sensor module 1240 may include, for example, an e-nose sensor, an electromyography (EMG) sensor, an electroencephalogram (EEG) sensor, an electrocardiogram (ECG) sensor, an infrared (IR) sensor, an iris sensor, and/or a fingerprint sensor. The sensor module 1240 may further include a control circuit for controlling one or more sensors included therein. The electronic device 1201 may further include a processor configured to control the sensor module 1240 as a part of, or separately from, the processor 1210, and may control the sensor module 1240 while the processor 1210 is in a sleep state.

The input device 1250 may include, for example, a touch panel 1252, a (digital) pen sensor 1254, a key 1256, or an ultrasonic input device 1258. The touch panel 1252 may use, for example, at least one of a capacitive type, a resistive type, an infrared type, and an ultrasonic type. Furthermore, the touch panel 1252 may further include a control circuit. The touch panel 1252 may further include a tactile layer to provide a tactile reaction to a user. The (digital) pen sensor 1254 may include, for example, a recognition sheet that is a part of, or separate from, the touch panel. The key 1256 may include, for example, a physical button, an optical key, or a keypad. The ultrasonic input device 1258 may detect ultrasonic waves, which are generated by an input tool, through a microphone 1288 to determine data corresponding to the detected ultrasonic waves.

The display 1260 may include a panel 1262, a hologram device 1264, a projector 1266, and/or a control circuit for controlling them. The panel 1262 may be embodied to be, for example, flexible, transparent, or wearable. The panel 1262, together with the touch panel 1252, may be configured as one or more modules. The panel 1262 may include a pressure sensor (or a force sensor), which may measure a strength of pressure of a user's touch. The pressure sensor may be embodied to be integrated with the touch panel 1252 or may be embodied as one or more sensors separated from the touch panel 1252. The hologram device 1264 may show a three dimensional image in the air by using interference of light. The projector 1266 may display an image by projecting light onto a screen. The screen may be located, for example, inside or outside the electronic device 1201. The interface 1270 may include, for example, an HDMI 1272, a USB 1274, an optical interface 1276, or a D-subminiature (D-sub) 1278. The interface 1270 may be included, for example, in the communication interface 170 illustrated in FIG. 1. Additionally or alternatively, the interface 1270 may include, for example, a mobile high-definition link (MEL) interface, an SD card/multi-media card (MMC) interface, or an infrared data association (IrDA) standard interface.

The audio module 1280, for example, may convert a sound into an electrical signal, and vice versa. At least some elements of the audio module 1280 may be included, for example, in the input/output interface 150 illustrated in FIG. 1. The audio module 1280 may process sound information that is input or output through, for example, a speaker 1282, a receiver 1284, earphones 1286, the microphone 1288, or the like. The camera module 1291 is a device that can photograph a still image and a moving image. The camera module 1291 may include one or more image sensors (e.g., a front sensor or a rear sensor), a lens, an image signal processor (ISP), or a flash (e.g., an LED, xenon lamp, or the like). The power management module 1295 may manage, for example, the power of the electronic device 1201. According to an embodiment, the power management module 1295 may include a power management integrated circuit (PMIC), a charger IC, or a battery gauge. The PMIC may use a wired and/or wireless charging method. Examples of the wireless charging method may include a magnetic resonance method, a magnetic induction method, an electromagnetic wave method, or the like. Additional circuits (e.g., a coil loop, a resonance circuit, a rectifier, or the like) for wireless charging may be further included. The battery gauge may measure, for example, the residual quantity of the battery 1296 and a voltage, current, or temperature while charging. The battery 1296 may include, for example, a rechargeable battery and/or a solar battery.

The indicator 1297 may indicate a particular state (e.g., a booting state, a message state, a charging state, and the like) of the electronic device 1201 or a part (e.g., the processor 1210) thereof. The motor 1298 may convert an electrical signal into a mechanical vibration and may generate a vibration, a haptic effect, or the like. The electronic device 1201 may include a mobile TV support device (e.g., GPU) that can process media data according to a standard, such as digital multimedia broadcasting (DMB), digital video broadcasting (DVB), mediaFlo™, or the like.

Each of the above-described component elements of hardware according to the present disclosure may be configured with one or more components, and the names of the corresponding component elements may vary based on the type of electronic device. In various embodiments, the electronic device 1201 may omit some elements or may further include additional elements, or some of the elements of the electronic device may be combined with each other to configure one entity, in which case the electronic device may identically perform the functions of the corresponding elements prior to the combination.

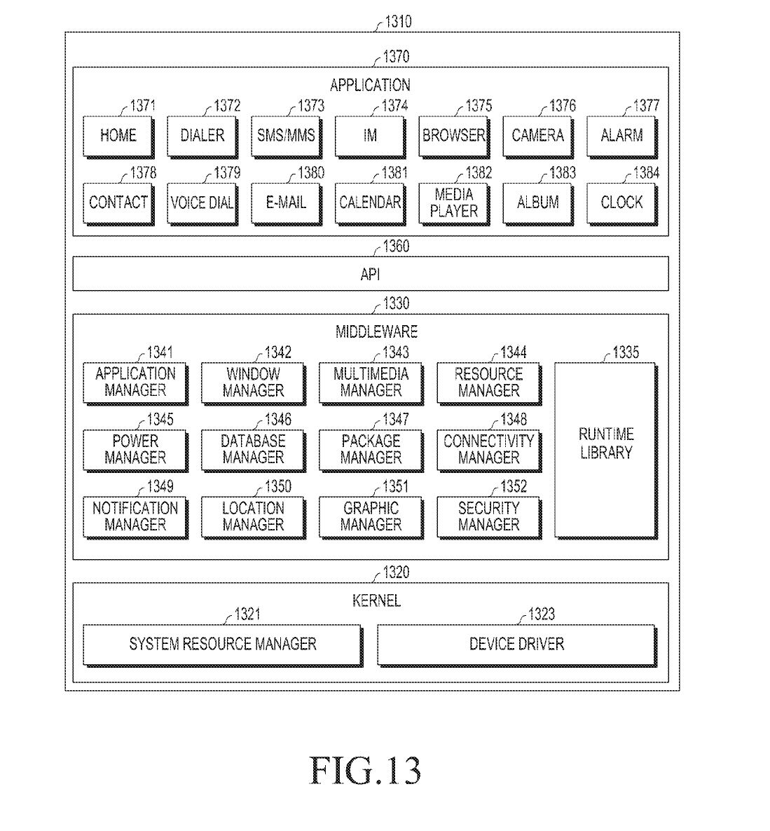

FIG. 13 is a block diagram of a program module according to embodiments of the present disclosure.

The program module 1310 may include an operating system (OS) that controls resources relating to an electronic device and/or various applications that are driven on the operating system. The operating system may include, for example, Android™, iOS™, Windows™, Symbian™, Tizen™, or Bada™. Referring to FIG. 13, the program module 1310 may include a kernel 1320, middleware 1330, an API 1360, and/or applications 1370. At least a part of the program module 1310 may be preloaded on the electronic device, or may be downloaded from an external electronic device.

The kernel 1320 may include, for example, a system resource manager 1321 and/or a device driver 1323. The system resource manager 1321 may control, allocate, or retrieve system resources. The system resource manager 1321 may include a process manager, a memory manager, or a file system manager. The device driver 1323 may include, for example, a display driver, a camera driver, a Bluetooth driver, a shared memory driver, a USB driver, a keypad driver, a Wi-Fi driver, an audio driver, or an inter-process communication (IPC) driver. The middleware 1330 may provide a function required by the applications 1370 in common, or may provide various functions to the applications 1370 through the API 1360 to enable the applications 1370 to use the limited system resources within the electronic device. The middleware 1330 may include at least one of a runtime library 1335, an application manager 1341, a window manager 1342, a multi-media manager 1343, a resource manager 1344, a power manager 1345, a database manager 1346, a package manager 1347, a connectivity manager 1348, a notification manager 1349, a location manager 1350, a graphic manager 1351, and a security manager 1352.

The runtime library 1335 may include, for example, a library module that a compiler uses in order to add a new function through a programming language while the application 1370 are being executed. The runtime library 1335 may manage an input/output, manage a memory, or process an arithmetic function. The application manager 1341 may manage, for example, the life cycle of the applications 1370. The window manager 1342 may manage GUI resources used for a screen. The multimedia manager 1343 may identify formats required for reproducing various media files, and may encode or decode a media file using a codec suitable for the corresponding format. The resource manager 1344 may manage the source code of the applications 1370 or the space of a memory. The power manager 1345 may manage, for example, the capacity or power of a battery and may provide power information required for operating the electronic device. The power manager 1345 may operate in conjunction with a basic input/output system (BIOS). The database manager 1346 may, for example, generate, search, or change a database to be used by the applications 1370. The package manager 1347 may manage the installation or updating of an application that is distributed in the form of a package file.

The connectivity manager 1348 may manage, for example, wireless connection. The notification manager 1349 may provide an event (e.g., an arrival message, an appointment, a proximity notification, or the like) to a user. The location manager 1350 may manage, for example, the location information of the electronic device. The graphic manager 1351 may manage, for example, a graphic effect to be provided to a user, or a user interface relating thereto. The security manager 1352 may provide, for example, system security or user authentication.

The middleware 1330 may include a telephony manager for managing a voice or video call function of the electronic device or a middleware module that is capable of forming a combination of the functions of the above-described elements. The middleware 1330 may provide a specialized module for each type of operation system. The middleware 1330 may dynamically remove some of the existing elements, or may add new elements. The API 1360 is, for example, a set of API programming functions, and may be provided in different configurations according to different operating systems. For example, in the case of Android or iOS, one API set may be provided for each platform, and in the case of Tizen, two or more API sets may be provided for each platform.

The applications 1370 may include, for example, home 1371, dialer 1372, SMS/MMS 1373, instant message (IM) 1374, browser 1375, camera 1376, alarm 1377, contacts 1378, voice dial 1379, e-mail 1380, calendar 1381, media player 1382, album 1383, clock 1384, health care (e.g., measuring exercise quantity or blood glucose), environment information providing application (e.g., atmospheric pressure, humidity, or temperature information), and the like. The applications 1370 may include an information exchange application that may support the exchanging of information between the electronic device and an external electronic device. The information exchange application may include, for example, a notification relay application for relaying predetermined information to an external electronic device, or a device management application for managing an external electronic device. For example, the notification relay application may relay notification information generated in the other applications of the electronic device to an external electronic device, or may receive notification information from an external electronic device to provide the received notification information to a user. The device management application may install, delete, or update a function (e.g., turning on/off of the external electronic device itself (or some elements thereof) or controlling of the brightness (or resolution) of a display) of an external electronic device that communicates with an electronic device, or an application that is operated in the external electronic device. The applications 1370 may include an application (e.g., a health care application of a mobile medical appliance) that is designated according to the attributes of an external electronic device. The applications 1370 may include an application received from an external electronic device. At least some of the program module 1310 may be implemented (e.g., executed) by software, firmware, hardware (e.g., the processor 1210), or a combination of at least two of them, and may include a module, a program, a routine, an instruction set, or a process for implementing one or more functions

According to an electronic device and a method of providing information in the electronic device of the present disclosure, an electronic device may switch a mode to another mode in the state in which the electronic device is connected to an access point (AP) based on a MU-MIMO mode or an SU-MIMO mode. Accordingly, when only a single electronic device is connected to the access point, the electronic device may switch a mode to the SU-MIMO mode, and may support a higher data transmission rate. When electronic devices of a plurality of users are connected to an AP, the electronic device may switch a mode to the MU-MIMO mode, and may transmit/receive data using a data transmission rate supported in the MU-MIMO mode. Therefore, the electronic device may show better performance.

The term “module” as used herein may include a unit consisting of hardware, software, or firmware, and may, for example, be used interchangeably with the term “logic”, “logical block”, “component”, “circuit”, or the like. The “module” may be an integrated component, or a minimum unit for performing one or more functions or a part thereof. The “module” may be mechanically or electronically implemented and may include, for example, an application-specific integrated circuit (ASIC) chip, a field-programmable gate arrays (FPGA), or a programmable-logic device, which has been known or are to be developed in the future, for performing certain operations. At least some of devices (e.g., modules or functions thereof) or methods (e.g., operations) may be implemented by an instruction which is stored a computer-readable storage medium (e.g., the memory 130) in the form of a program module. The instruction, when executed by a processor (e.g., the processor 120), may cause the one or more processors to execute the function corresponding to the instruction. The computer-readable storage medium may include a hard disk, a floppy disk, a magnetic medium (e.g., a magnetic tape), an optical media (e.g., CD-ROM, DVD), a magneto-optical media (e.g., a floptical disk), an inner memory, etc. The instruction may include a code which is made by a compiler or a code which may be executed by an interpreter. The programming module may include one or more of the aforementioned components or may further include other additional components, or some of the aforementioned components may be omitted. Operations performed by a module, a program module, or other elements may be executed sequentially, in parallel, repeatedly, or heuristically, or at least a few operations may be executed in a different order or may be omitted, or another operation may be added.

According to embodiments of the present disclosure, there is provided a computer readable recording medium that records a program to be implemented on a computer, wherein the program may enable a processor to perform operations when the program is executed by the processor, the operations including obtaining information for mode switching in the state of being connected with an access point based on a first mode from among a multiple user multiple input multiple output (MU-MIMO) mode and a single user multiple input multiple output (SU-MIMO); determining whether to switch a mode to a second mode, which is different from the first mode, from among the MU-MIMO and the SU-MIMO, based on the obtained information for mode switching; and performing wireless data communication with the access point based on the switched second mode when the electronic device is switched to the second mode according to the determination.

Various embodiments disclosed herein are provided merely to easily describe technical details of the present disclosure and to help the understanding of the present disclosure, and are not intended to limit the scope of the present disclosure. Therefore, it should be construed that all modifications and changes or modified and changed forms based on the technical idea of the present disclosure fall within the scope of the present disclosure, as defined by the claims below and their equivalents.

What is claimed is:

1. An electronic device, comprising:
a communication module that performs wireless data communication with an access point; and
a processor configured to perform:
obtaining information for mode switching when the electronic device is connected to the access point based on one of a first mode from among a multiple user multiple input multiple output (MU-MIMO) mode and a single user multiple input multiple output (SU-MIMO) mode;
determining whether to switch the mode to a second mode, which is different from the first mode, from among the MU-MIMO mode and the SU-MIMO based on the obtained information for mode switching; and
performing wireless data communication with the access point based on the second mode when the electronic device is switched to the second mode.

2. The electronic device of claim 1, wherein, when the first mode is the MU-MIMO mode and the second mode is the SU-MIMO mode, the processor determines the number of electronic devices connected to the access point based on the information for mode switching obtained when the electronic device is connected to the access point in the MU-MIMO mode; and
when the number of electronic devices connected to the access point is 1, switches the MU-MIMO mode to the SU-MIMO mode.

3. The electronic device of claim 1, wherein, when the first mode is the MU-MIMO mode and the second mode is the SU-MIMO mode, the processor obtains a maximum data transmission rate determined in the MU-MIMO mode as the information for mode switching; and
switches the MU-MIMO mode to the SU-MIMO mode when the obtained maximum data transmission rate is less than a maximum data transmission rate set for the SU-MIMO mode.

4. The electronic device of claim 3, wherein the processor determines the number of antennas that the access point allocates to the electronic device based on the obtained maximum data transmission rate; and
activates at least one of the antennas based on the number of antennas of the access point allocated to the electronic device.

5. The electronic device of claim 1, wherein, when the first mode is the SU-MIMO mode and the second mode is the MU-MIMO mode, the processor obtains as the information for mode switching, a current data transmission rate determined through execution of wireless data communication with the access point in the SU-MIMO mode; and
switches the SU-MIMO mode to the MU-MIMO mode when the determined current data transmission rate is less than a maximum data transmission rate set for the MU-MIMO mode.

6. The electronic device of claim 1, wherein, when the first mode is the SU-MIMO mode and the second mode is the MU-MIMO mode, the processor determines the number of electronic devices connected to the access point based on the obtained information for mode switching; and
switches the SU-MIMO mode to the MU-MIMO mode when the number of electronic devices connected to the access point is greater than or equal to 2.

7. The electronic device of claim 1, wherein the processor transmits a connection related message including information indicating that the electronic device is switched to the second mode when the mode is switched to the second mode; and
performs a control to perform wireless data communication with the access point based on the second mode when the electronic device is connected to the access point based on the second mode.

8. The electronic device of claim 1, wherein obtained information includes at least one of the number of electronic devices connected to the access point, a maximum data transmission rate allocated to the electronic device, and current data throughput information determined in the electronic device.

9. The electronic device of claim 7, wherein the processor, when the mode is switched to the SU-MIMO mode as the second mode, generates, as the connection related message, a re-connection request message or an action frame request message including a related field indicating whether the MU-MIMO mode is supported, in which information indicating that the MU-MIMO mode is not supported is set; and
transmits the generated re-connection request message or action frame request message when the electronic device is connected to the access point.

10. The electronic device of claim 7, wherein the processor executes a control to disconnect a wireless communication connection with the access point when the electronic device is switched to the SU-MIMO mode;
generates, as the connection related message, a connection request message including a related field indicating whether the MU-MIMO mode is supported, which is set as information indicating that the MU-MIMO mode is not supported; and
transmits the generated connection request message to the access point.

11. A wireless communication method of an electronic device that performs wireless data communication with an access point, the method comprising:
obtaining information for mode switching when the electronic device is connected to the access point based on one of a first mode from among a multiple user multiple input multiple output (MU-MIMO) mode and a single user multiple input multiple output (SU-MIMO) mode;
determining whether to switch the mode to a second mode, which is different from the first mode, from among the MU-MIMO mode and the SU-MIMO mode based on the obtained information for mode switching; and
performing wireless data communication with the access point based on the second mode when the electronic device is switched to the second mode.

12. The method of claim 11, wherein determining whether to switch the mode to the second mode, which is different from the first mode, comprises:
determining the number of electronic devices connected to the access point based on the information for mode switching obtained when the electronic device is connected to the access point based on the MU-MIMO mode when the first mode is the MU-MIMO mode and the second mode is SU-MIMO mode; and
switching the MU-MIMO mode to the SU-MIMO mode when the number of electronic devices connected to the access point is 1.

13. The method of claim 11, wherein determining whether to switch the mode to the second mode, which is different from the first mode, comprises:
obtaining, as the information for mode switching, a maximum data transmission rate determined in the MU-MIMO mode when the first mode is the MU-MIMO mode and the second mode is the SU-MIMO mode;
comparing the obtained maximum data transmission rate and a maximum data transmission rate set for the MU-MIMO mode; and
switching the MU-MIMO mode to the SU-MIMO mode when the obtained maximum data transmission rate is less than the maximum transmission data rate set for the MU-MIMO mode.

14. The method of claim 13, wherein determining whether to switch the mode to the second mode, which is different from the first mode, comprises:
determining the number of antennas that the access point allocates to the electronic device based on the obtained maximum data transmission rate; and
activating at least one of the antennas based on the number of antennas of the access point allocated to the electronic device.

15. The method of claim 11, wherein determining whether to switch the mode to the second mode, which is different from the first mode, comprises:
obtaining, as the information for mode switching, a current data transmission rate determined during wireless data communication with the access point performed based on the SU-MIMO mode when the first mode is the SU-MIMO mode and the second mode is the MU-MIMO mode;
comparing the obtained current data transmission rate and a maximum data transmission rate set for the SU-MIMO mode; and
determining to switch the SU-MIMO mode to the MU-MIMO mode when the obtained current data transmission rate is less than the maximum data transmission rate set for the SU-MIMO mode.

16. The method of claim 11, wherein determining whether to switch the mode to the second mode, which is different from the first mode, comprises:
determining the number of electronic devices connected to the access point based on the obtained information for mode switching when the first mode is the SU-MIMO mode and the second mode is the MU-MIMO mode; and
switching the SU-MIMO mode to the MU-MIMO mode when the number of electronic devices connected to the access point is greater than or equal to 2.

17. The method of claim 11, further comprising:
transmitting a connection related message including information indicating that the electronic device is switched to the second mode when the electronic device is switched to the second mode; and
performing wireless data communication with the access point based on the second mode when the electronic device is connected to the access point based on the second mode.

18. The method of claim 17, wherein transmitting the connection related message, comprises:
generating, as the connection related message, a re-connection request message or an action frame request message including a related field indicating whether the MU-MIMO mode is supported, which is set as information indicating that the MU-MIMO mode is not supported, when the electronic device is switched to the SU-MIMO mode as the second mode; and
transmitting the generated re-connection request message or the action frame request message when the electronic device is connected to the access point.

19. The method of claim 17, wherein transmitting the connection related message, comprises:
disconnecting a wireless communication connection with the access point when the electronic device is switched to the SU-MIMO mode as the second mode;
generating, as the connection related message, a connection request message including a related field indicating whether the MU-MIMO mode is supported, which is set as information indicating that the MU-MIMO mode is not supported; and
transmitting the generated connection request message to the access point.

20. A non-transitory computer readable recording medium that stores a program to be implemented on a computer, wherein the program includes executable instructions to enable a processor to perform operations when the program is executed by the processor, the operations comprising:
obtaining information for mode switching when an electronic device is connected to an access point based on one of a first mode from among a multiple user multiple input multiple output (MU-MIMO) mode and a single user multiple input multiple output (SU-MIMO) mode;
determining whether to switch the mode to a second mode, which is different from the first mode, from among the MU-MIMO mode and the SU-MIMO mode based on the obtained information for mode switching; and
performing wireless data communication with the access point based on the second mode when the electronic device is switched to the second mode.
